(19) United States
(12) Patent Application Publication
(10) Pub. No.: US 2025/0094192 A1
(43) Pub. Date: Mar. 20, 2025

(54) MONITORING APPARATUS AND MONITORING METHOD

(71) Applicant: Panasonic Automotive Systems Co., Ltd., Kanagawa (JP)

(72) Inventors: Yoshiharu IMAMOTO, Kanagawa (JP); Ryo HIRANO, Kanagawa (JP)

(73) Assignee: Panasonic Automotive Systems Co., Ltd., Kanagawa (JP)

(21) Appl. No.: 18/965,570

(22) Filed: Dec. 2, 2024

Related U.S. Application Data
(63) Continuation of application No. PCT/JP2023/003814, filed on Feb. 6, 2023.

(30) Foreign Application Priority Data
Jun. 10, 2022 (JP) 2022-094421

(51) Int. Cl. G06F 9/455; G06F 9/451

(52) U.S. Cl. CPC G06F 9/45533; G06F 9/452

(57) ABSTRACT

An integrated ECU, which is a monitoring apparatus, includes: a virtual command generator that obtains a physical signal and converts the physical signal into a virtual command; a virtual command notifier that transmits the virtual command to a control virtual machine; and a virtual command preparation component that causes a first command monitor to monitor the virtual command after the virtual command has been transmitted to the control virtual machine by the virtual command notifier.

### CROSS REFERENCE TO RELATED APPLICATIONS

This is a continuation application of PCT International Application No. PCT/JP2023/003814 filed on Feb. 6, 2023, designating the United States of America, which is based on and claims priority of Japanese Patent Application No. 2022-094421 filed on Jun. 10, 2022.

### FIELD

The present disclosure relates to a monitoring apparatus and monitoring method for monitoring, for example, commands.

### BACKGROUND

A monitoring apparatus according to Patent Literature (PTL) 1 monitors a virtual machine to be monitored on virtual software by using a monitoring virtual machine on the virtual software. For example, the monitoring apparatus verifies the virtual machine to be monitored and a hypervisor using the monitoring virtual machine at predetermined time intervals and obtains the results of the verification.

### CITATION LIST

### Patent Literature

PTL 1: Japanese Unexamined Patent Application Publication No. 2019-144785

### SUMMARY

However, the monitoring apparatus according to PTL 1 can be improved upon.

In view of this, the present disclosure provides a monitoring apparatus and the like capable of improving upon the above related art.

A monitoring apparatus according to one aspect of the present disclosure is a monitoring apparatus that monitors a virtual command, the virtual command being a command for a virtual machine, the monitoring apparatus including: a memory; and a processor connected to the memory. The processor: obtains a physical signal and executes a virtual command generation process for converting the physical signal into the virtual command; executes a virtual command notification process for transmitting the virtual command to the virtual machine; and executes a virtual command preparation process for causing a command monitor to monitor the virtual command after the virtual command has been transmitted to the virtual machine by the virtual command notification process.

Note that these general and specific aspects may be implemented using a system, a method, an integrated circuit, a computer program, or a computer-readable recording medium such as a compact disc read-only memory (CD-ROM), or any combination of systems, methods, integrated circuits, computer programs, and recording media. The recording medium may also be a non-transitory recording medium.

The monitoring apparatus of the present disclosure can be improved upon.

Further advantages and effects of one aspect of the present disclosure will be apparent from the description and drawings. Such advantages and/or effects are provided by some embodiments and configurations described in the specification and drawings, but not all configurations need to be provided to obtain the advantages and effects.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is an overall configuration diagram of a monitoring system according to an embodiment.

FIG. 2 is a block diagram illustrating an example of a configuration of an integrated electronic control unit (ECU) according to the embodiment.

FIG. 3 is a block diagram illustrating in detail a configuration of a portion of the integrated ECU according to the embodiment.

FIG. 4 is a diagram illustrating examples of virtual commands according to the embodiment.

FIG. 5 is a diagram illustrating an example of an internal configuration of a virtual command according to the embodiment.

FIG. 6 is a block diagram illustrating an example of a detailed configuration of a virtualization platform according to the embodiment.

FIG. 7 is a block diagram illustrating an example of a configuration of a virtual command preparation component according to the embodiment.

FIG. 8 is a flowchart illustrating an example of processing operations performed by the virtualization platform of the integrated ECU according to the embodiment.

FIG. 9 is a diagram illustrating an example of virtual command duplication by a virtual command notifier according to the embodiment.

FIG. 10 is a flowchart illustrating an example of a delay processing task performed by the virtual command preparation component according to the embodiment.

FIG. 11 is a flowchart illustrating an example of a log recorded by the virtual command preparation component according to the embodiment.

FIG. 12 is a flowchart illustrating an example of monitoring switch processing performed by the virtual command preparation component according to the embodiment.

FIG. 13 is a block diagram illustrating an example of a detailed configuration of a virtualization platform according to a variation of the embodiment.

FIG. 14 is a block diagram illustrating an example of a configuration of a virtual command preparation component according to the variation of the embodiment.

FIG. 15 is a block diagram illustrating an example of a configuration of a virtual command generator according to the variation of the embodiment.

FIG. 16 is a flowchart illustrating an example of processing operations performed by the virtualization platform of the integrated ECU according to the variation of the embodiment.

FIG. 17 is a sequence diagram illustrating processing operations performed by a plurality of components included in the integrated ECU according to the variation of the embodiment.

FIG. 18 is a diagram illustrating an example of an image shown on a display by a screen outputter of a video virtual machine according to the variation of the embodiment.

### DESCRIPTION OF EMBODIMENT

### (Underlying Knowledge Forming Basis of the Present Disclosure)

In the monitoring apparatus according to PTL 1, since verification is performed at each predetermined time interval, if an unauthorized command is transmitted to the virtual machine during that time interval, immediate detection of an anomaly in the command is difficult. That is, immediate detection of an anomaly is difficult in the monitoring apparatus according to PTL 1. If the predetermined time interval is shortened, that is, if commands to be transmitted to the virtual machine are sequentially monitored in advance, the transmission of the commands could be delayed. A technique has been proposed to detect unauthorized communication by duplicating a packet, such as a command, that is input to a mirror port and monitoring the duplicated packet. In other words, this is a technique to perform port mirroring in an intrusion detection system (IDS). However, this port mirroring has a problem of overhead involved in duplication.

In order to solve such a problem, a monitoring apparatus according to one aspect of the present disclosure is a monitoring apparatus that monitors a virtual command, the virtual command being a command for a virtual machine, the monitoring apparatus including: a memory; and a processor connected to the memory. The processor: obtains a physical signal and executes a virtual command generation process for converting the physical signal into the virtual command; executes a virtual command notification process for transmitting the virtual command to the virtual machine; and executes a virtual command preparation process for causing a command monitor to monitor the virtual command after the virtual command has been transmitted to the virtual machine by the virtual command notification process.

Thus, the monitoring of the virtual command is delayed, and the virtual command is transmitted prior to the monitoring, which can reduce communication delays caused by sequential monitoring of virtual commands. When the virtual command is transmitted prior to the monitoring and is then determined to be anomalous, the occurrence or expansion of the anomaly can be appropriately prevented by prohibiting the transmission of a subsequent virtual command having similar characteristics to the anomalous virtual command.

When causing the command monitor to monitor the virtual command, the virtual command preparation component may access a buffer that stores at least a portion of each of one or more virtual commands, determine, for each of the one or more virtual commands, whether the at least a portion of the virtual command is assigned an identifier indicating that the virtual command is to be monitored after the virtual command is transmitted to the virtual machine, and cause the command monitor to monitor the virtual command to which the identifier is assigned.

Thus, the virtual command to be monitored can be identified correctly, preventing an unnecessary process such as monitoring a virtual command not to be monitored.

The virtual command preparation component may further determine whether a storage area of the buffer has been reused, and when determining that the storage area has been reused, the virtual command preparation component may record that a virtual command has been missed.

This enables proper management of virtual commands.

The virtual command notifier may further duplicate a portion of the virtual command, assign the identifier to the portion of the virtual command duplicated, and store, into the buffer, the portion of the virtual command to which the identifier is assigned.

This can reduce the generation of overhead involved in duplication.

Hereinafter, an exemplary embodiment will be described with reference to the drawings.

Note that an embodiment described below shows a general or specific example. The numerical values, shapes, materials, components, arrangement positions and connection forms of the components, steps, the order of the steps, and the like shown in the following embodiment are examples and are not intended to limit the present disclosure. Among the components in the following embodiment, components that are not recited in the independent claims that indicate the highest-level concepts will be described as optional components.

Each of the drawings is a schematic view and is not necessarily a strict illustration. In the drawings, the same components are denoted by the same reference numerals.

### EMBODIMENT

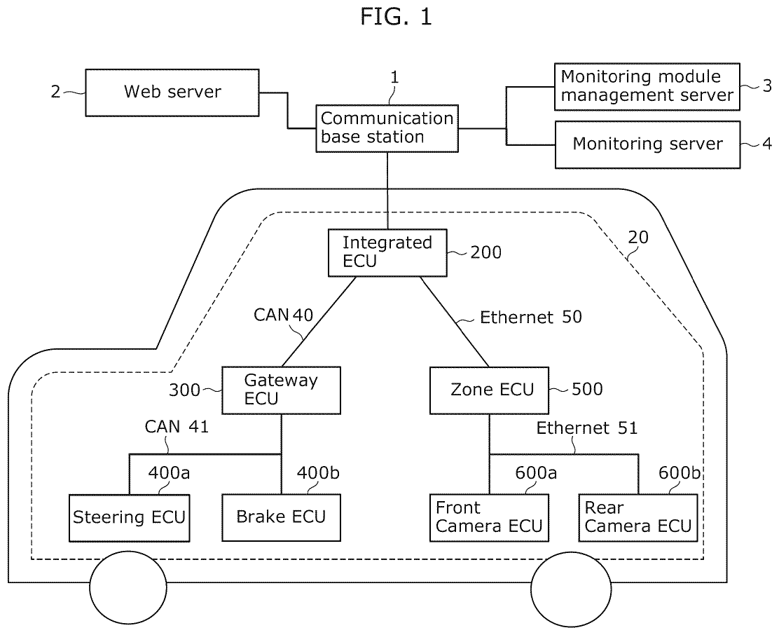

FIG. 1 is an overall configuration diagram of a monitoring system according to the present embodiment.

The monitoring system according to the present embodiment includes communication base station 1, web server 2, monitoring module management server 3, monitoring server 4, and in-vehicle system 20.

Communication base station 1 is connected to web server 2, monitoring module management server 3, monitoring server 4, and in-vehicle system 20, and relays communication between each of the servers and in-vehicle system 20. Note that these servers and system may be connected via an external network. For example, the external network is the Internet. The communication method of the external network may be wired or wireless. The wireless communication method may be an existing technology such as Wi-Fi (registered trademark), third-generation long-term evolution (3G/LTE), Bluetooth (registered trademark), or vehicle-to-everything (V2X) communication. Web server 2 provides, for example, a website related to unauthorized communication and the like. Monitoring module management server 3 manages, for example, a monitoring module in in-vehicle system 20. Monitoring server 4 monitors irregularities or anomalies in in-vehicle system 20. For example, monitoring server 4 is an apparatus that obtains monitoring results, which are information related to the security state of in-vehicle system 20 from in-vehicle system 20, and displays the monitoring results using a graphical user interface. Monitoring server 4 is used, for example, when a security analyst checks the monitoring results at a security operation center and considers measures, such as a software update, in the event of an anomaly in in-vehicle system 20.

In-vehicle system 20 performs communication control, vehicle control, video output, and the like, monitors the security state of in-vehicle system 20, and notifies monitoring server 4 of the monitoring results of the security state. Although only one in-vehicle system 20 is illustrated in FIG. 1, each of one or more in-vehicle systems 20 may transmit the monitoring results of the security state to monitoring server 4.

In-vehicle system 20 includes integrated ECU 200, gateway ECU 300, steering ECU 400a, brake ECU 400b, Zone ECU 500, front camera ECU 600a, and rear camera ECU 600b.

Integrated ECU 200 and gateway ECU 300 are connected via CAN 40, a Controller Area Network (CAN), which is a type of network protocol. The network protocol used here is not limited to CAN but may be a network protocol used in an in-vehicle system, such as the Controller Area Network with Flexible Data-rate (CAN-FD) or the FlexRay protocol.

Gateway ECU 300, steering ECU 400a, and brake ECU 400b are connected via CAN 41.

Integrated ECU 200 and Zone ECU 500 are connected via Ethernet 50, an Ethernet (trademark) protocol, which is a type of network protocol. Ethernet 50 is, for example, the Scalable Service-Oriented Middleware over IP (SOME/IP) protocol. The network protocol used here may be a network protocol used in an in-vehicle system, such as Scalable Service-Oriented Middleware over IP—Service Discovery (SOME/IP-SD) or Controller Area Network Extra Long (CAN-XL), instead of SOME/IP.

Zone ECU 500, front camera ECU 600a, and rear camera ECU 600b are connected via Ethernet 51. Ethernet 51 may be the same network protocol as Ethernet 50 or a different network protocol.

Integrated ECU 200 is connected to web server 2, monitoring module management server 3, and monitoring server 4 via the external network, communication base station 1, or the like.

Integrated ECU 200 is an ECU that performs communication control for transmitting and receiving messages via the external network, communication base station 1, CAN 40, and Ethernet 50, vehicle control for instructing gateway ECU 300 and Zone ECU 500 to control the vehicle via CAN 40 and Ethernet 50, and video output to the infotainment system and instrument panel. Integrated ECU 200 monitors the security state of integrated ECU 200 and notifies monitoring server 4 of the monitoring results. Note that integrated ECU 200 according to the present embodiment is an example of a monitoring apparatus, the details of which will be described later.

Gateway ECU 300 is an ECU that mediates messages transmitted and received between Integrated ECU 200 and each of steering ECU 400a and brake ECU 400b.

Steering ECU 400a is an ECU that controls steering performed by a steering wheel installed in the vehicle. Brake ECU 400b controls brakes installed in the vehicle.

In addition to steering ECU 400a and brake ECU 400b, in-vehicle system 20 uses ECUs that control the engine and body of the vehicle to implement control of driving, turning, and stopping of the vehicle.

Zone ECU 500 is an ECU that mediates messages transmitted and received between integrated ECU 200 and each of front camera ECU 600a and rear camera ECU 600b. Front Camera ECU 600a is installed at the front of the vehicle and obtains video from a camera that captures the front of the vehicle. Rear camera ECU 600b is installed at the rear of the vehicle and obtains video from a camera that captures the rear of the vehicle.

Although only the front camera ECU and the rear camera ECU are illustrated in FIG. 1, advanced driving support functions such as autonomous driving, adaptive cruise control, and automatic parking may be implemented using ECUs that collect various sensor information such as the global positioning system (GPS). The messages described above may be packets or commands.

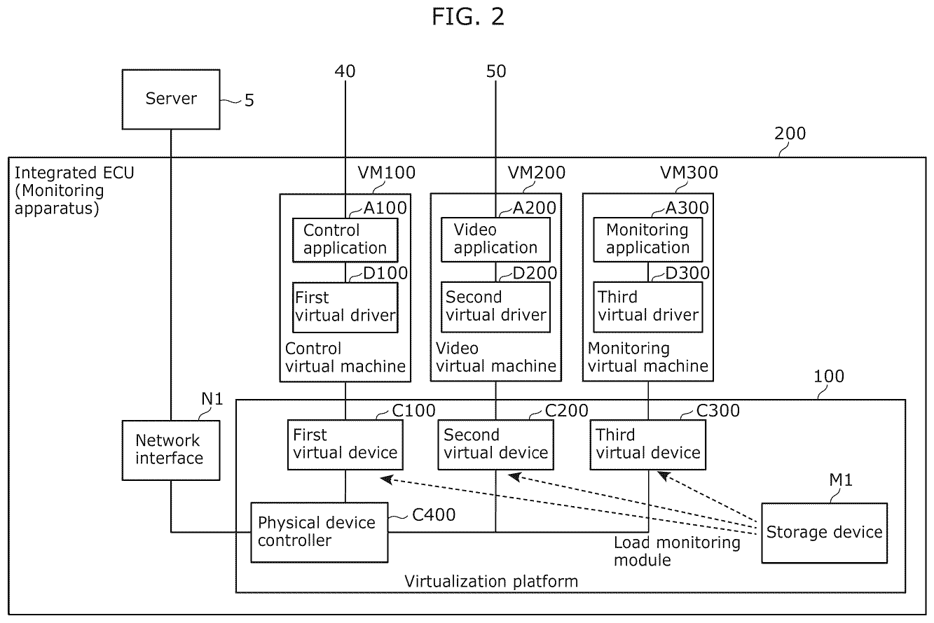

FIG. 2 is a block diagram illustrating an example of the configuration of integrated ECU 200.

Integrated ECU 200 includes network interface N1, virtualization platform 100, control virtual machine VM100, video virtual machine VM200, and monitoring virtual machine VM300. Note that each of control virtual machine VM100, video virtual machine VM200, and monitoring virtual machine VM300 may hereinafter be collectively referred to as a virtual machine.

Network interface N1 includes a function of interfacing communication between server 5 and virtualization platform 100. Note that server 5 includes at least one of web server 2, monitoring module management server 3, or monitoring server 4.

Virtualization platform 100 is a virtual software infrastructure, such as a hypervisor, and is software that executes and manages one or more virtual machines. In general, hypervisors are distinguished between bare-metal hypervisors, called Type 1, and hosted hypervisors, called Type 2. In embedded systems, Type 1 is generally used, considering the overhead of processing by the hypervisor. The Type-1 hypervisor is less likely to contain vulnerabilities because of its small code size and can be assumed to be more reliable than applications and virtual machines. Virtualization platform 100 may be a hypervisor using MicroKernel. In this case, virtualization platform 100 is implemented as a process. Note that Type-1 virtualization platform 100 is implemented as a process of a service operating system (OS), that is, a process of one virtual machine. In the present embodiment, the type of virtualization platform 100 is not particularly limited and may be any type.

Virtualization platform 100 includes first virtual device C100, second virtual device C200, third virtual device C300, physical device controller C400, and storage device M1. Note that each of first virtual device C100, second virtual device C200, and third virtual device C300 may hereinafter be collectively referred to as a virtual device.

Physical device controller C400 is connected to server 5 via network interface N1, and further connected to first virtual device C100, second virtual device C200, and third virtual device C300. Physical device controller C400 controls, for example, communication between server 5 and each of first virtual device C100, second virtual device C200, and third virtual device C300.

Storage device M1 holds monitoring modules that are loaded into first virtual device C100, second virtual device C200, and third virtual device C300, respectively. The plurality of monitoring modules held in storage device M1 are associated with first virtual device C100, second virtual device C200, and third virtual device C300 according to a configuration file when virtualization platform 100 is initialized. The configuration file defines which monitoring module is set to which virtual device. A plurality of monitoring modules may be loaded and arranged in one virtual device.

First virtual device C100, second virtual device C200, and third virtual device C300 are connected to control virtual machine VM100, video virtual machine VM200, and monitoring virtual machine VM300, respectively. These virtual devices monitor and control communication between physical device controller C400 and the virtual machines.

Control virtual machine VM100 is an operating system that runs control application A100 using first virtual driver D100. Control application A100 is an application software program that communicates with gateway ECU 300 via CAN 40 and controls operations related to the travel of the vehicle equipped with in-vehicle system 20.

video virtual machine VM200 is an operating system that runs video application A200 using second virtual driver D200. Video application A200 is an application software program that communicates with Zone ECU 500 via Ethernet 50, obtains camera video and the like, and outputs the video to the infotainment system, instrument panel, head-up display, and the like. The camera video is also used as information for implementing advanced driving support functions such as autonomous driving.

Monitoring virtual machine VM300 is an operating system that runs monitoring application A300 using third virtual driver D300. Monitoring application A300 is, for example, an application software program that monitors virtual machines other than monitoring virtual machine VM300, virtualization platform 100, and the like.

Note that integrated ECU 200 according to the present embodiment uses, for example, paravirtualization technology (virtio). This paravirtualization technology is a technology for providing a standard interface to the virtual machines on virtualization platform 100 and enables high-speed communication with physical devices (storage, network devices, etc.) connected to virtualization platform 100.

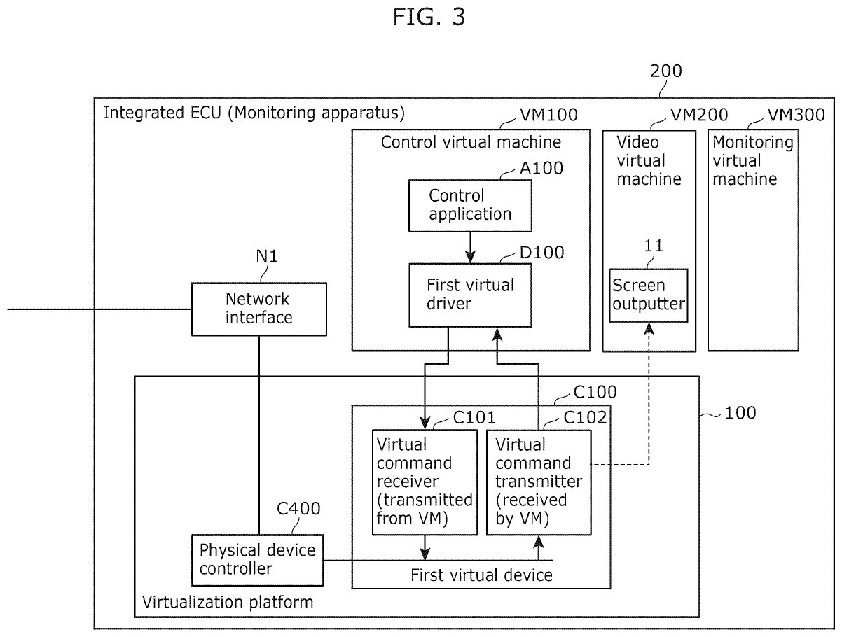

FIG. 3 is a block diagram illustrating in detail a configuration of a portion of integrated ECU 200.

For example, as illustrated in FIG. 3, first virtual device C100 of virtualization platform 100 includes virtual command receiver C101 and virtual command transmitter C102. Virtual command receiver C101 receives a virtual command transmitted from first virtual driver D100 of control virtual machine VM100, converts the virtual command into, for example, a physical signal, and transmits the physical signal to physical device controller C400.

Virtual command transmitter C102 receives a physical signal transmitted from physical device controller C400, converts the physical signal into a virtual command, and transmits the virtual command to first virtual driver D100 of control virtual machine VM100. First virtual driver D100 receives that virtual command. Virtual command transmitter C102 also monitors the virtual command using, for example, a monitoring module loaded in virtual command transmitter C102. Virtual command transmitter C102 may determine whether the virtual command or the state of first virtual device C100 is normal or anomalous based on the monitoring results, and notify screen outputter 11 of video virtual machine VM200 of the anomaly determination result.

Video virtual machine VM200 operates screen outputter 11. Screen outputter 11 displays the anomaly determination result notified from virtual command transmitter C102 on a display provided in the vehicle. For example, screen outputter 11 reflects the anomaly determination result on an icon shown on the display. Such an anomaly determination result may be periodically notified to screen outputter 11.

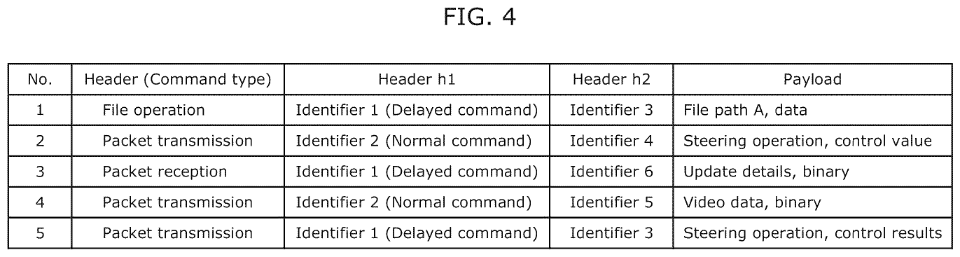

FIG. 4 is a diagram illustrating examples of virtual commands.

For example, a plurality of virtual commands generated by conversion by virtual command transmitter C102 are stored in a buffer in virtualization platform 100 or virtual command transmitter C102. As illustrated in FIG. 4, for example, each of these virtual commands includes a number such as a sequence number, a command-type header, header h1, header h2, and a payload. The command-type header indicates the command type, such as file operation, packet transmission, or packet reception. Header h1 indicates whether the virtual command is a delayed command or a normal command. The delayed command is a virtual command to be delayed in monitoring or a duplicated virtual command. The normal command is a virtual command not to be delayed in monitoring. The normal command is a virtual command that has not been duplicated or a virtual command serving as the duplication source. Header h2 indicates the transmission destination, transmission source, or other information of the virtual command. The transmission destination or transmission source may be a storage device or an external ECU. The payload includes a file path, data, steering control data, a control value, update details, binary data, or other information. Note that the buffer for recording virtual commands can be implemented as a ring buffer or a list structure to store a plurality of commands. By further providing buffers for transmission, reception, and data backup, efficient data processing can be implemented.

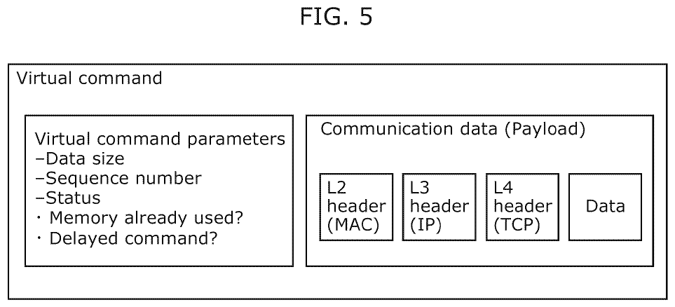

FIG. 5 is a diagram illustrating an example of an internal configuration of a virtual command.

The virtual command includes a plurality of parameters and communication data. The plurality of parameters may indicate the sequence number described above and may be included in the command-type header, header h1, header h2, or the like. The plurality of parameters may also indicate the data size of the virtual command. The plurality of parameters may also indicate the status of the virtual command. The status indicates whether a storage area for the virtual command stored in a memory, which is a buffer, has been used and whether the virtual command is a delayed command. In other words, a part of the status can be said to be indicated by header h1 described above.

The communication data is stored in the payload described above. For example, the communication data includes an L2 header, an L3 header, an L4 header, and data. The L2 header is a media access control address (MAC) header, the L3 header is an internet protocol (IP) header, and the L4 header is a transmission control protocol (TCP) header. The data indicates the file path, control value, and the like, as described above.

Note that such a virtual command may be transmitted as a packet.

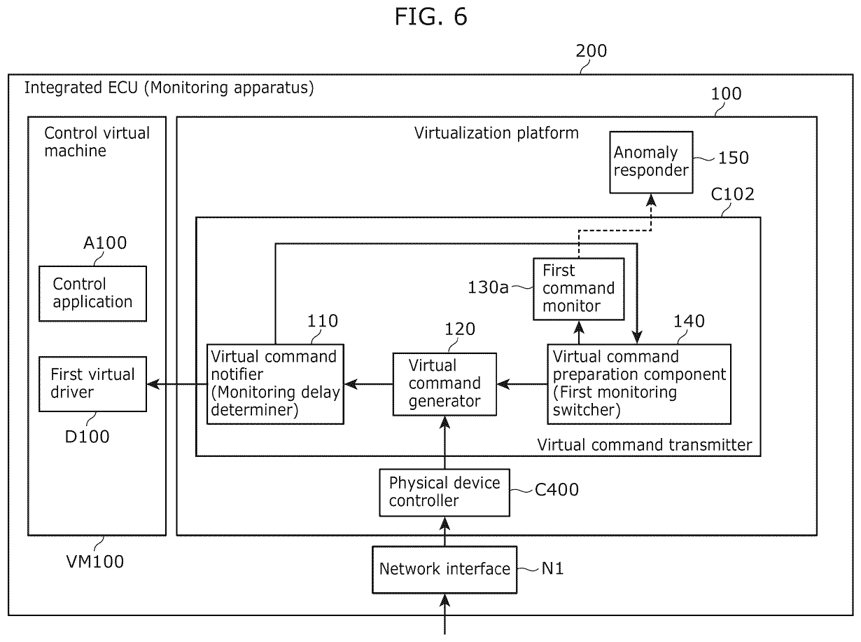

FIG. 6 is a block diagram illustrating an example of a detailed configuration of virtualization platform 100.

Virtualization platform 100 includes virtual command transmitter C102 and physical device controller C400 as described above, and further includes anomaly responder 150. Anomaly responder 150 receives notification of the anomaly determination result from virtual command transmitter C102. When the notified anomaly determination result indicates an anomaly, anomaly responder 150 prohibits the transmission of the virtual command corresponding to the anomaly determination result to the virtual machine, that is, the virtual command following the virtual command determined to be anomalous. In other words, anomaly responder 150 prohibits the transmission of the virtual command to the virtual machine by virtual command generator 120 and virtual command notifier 110, which will be described later. Anomaly responder 150 may also record a log indicating the anomaly determination result.

Virtual command transmitter C102 includes virtual command notifier 110, virtual command generator 120, virtual command preparation component 140, and first command monitor 130a. Virtual command generator 120 receives a physical signal from physical device controller C400 and converts the physical signal into a virtual command. That is, this conversion generates a virtual command. Then, Virtual command generator 120 transmits the virtual command to virtual command notifier 110. Virtual command generator 120 may store the generated virtual command into the buffer provided in virtual command transmitter C102, for example.

Virtual command notifier 110 receives the virtual command from virtual command generator 120 and transmits the virtual command to first virtual driver D100 of control virtual machine VM100. In other words, virtual command notifier 110 notifies first virtual driver D100 of the virtual command. Here, when notifying first virtual driver D100 of the virtual command, virtual command notifier 110 determines whether to delay the monitoring of the virtual command by first command monitor 130a. When determining to delay the monitoring, virtual command notifier 110 transmits the virtual command to first virtual driver D100 prior to the monitoring performed on the virtual command. On the other hand, when determining not to delay the monitoring, virtual command notifier 110 waits without transmitting the virtual command so that the virtual command is monitored before being transmitted to first virtual driver D100. After the monitoring is performed, virtual command notifier 110 transmits the virtual command to first virtual driver D100. Such virtual command notifier 110 determines whether to delay the monitoring and can thus be said to include a monitoring delay determiner. Virtual command notifier 110 may also determine whether to delay the monitoring based on the above parameters of the virtual command.

Virtual command notifier 110 backs up and duplicates the virtual command to cause first command monitor 130a to monitor the virtual command. The virtual command thus duplicated is treated as the delayed command described above. Virtual command notifier 110 changes the parameters of the virtual command thus duplicated to parameters indicating the delayed command. In other words, virtual command notifier 110 marks the delayed command. Note that virtual command notifier 110 may duplicate all the virtual commands generated by virtual command generator 120, or each time a plurality of virtual commands are generated, virtual command notifier 110 may duplicate only one of those plurality of virtual commands.

Note that the virtual command may be transmitted and received within virtual command transmitter C102, for example, via the buffer provided in virtual command transmitter C102.

Virtual command preparation component 140 ensures a storage area for a virtual command generated by virtual command generator 120 to store the virtual command in the buffer. This executes preparation for the virtual command. Moreover, virtual command preparation component 140 obtains a virtual command stored in the buffer as a delayed command and causes first command monitor 130a to monitor the virtual command. At this time, if there is another command monitor in addition to first command monitor 130a, as well as first command monitor 130a, virtual command preparation component 140 may switch the command monitor used for monitoring. In this case, virtual command preparation component 140 can be said to include a first monitoring switcher. The process by virtual command preparation component 140 for monitoring the virtual command is performed in parallel with the transmission of another virtual command by virtual command notifier 110.

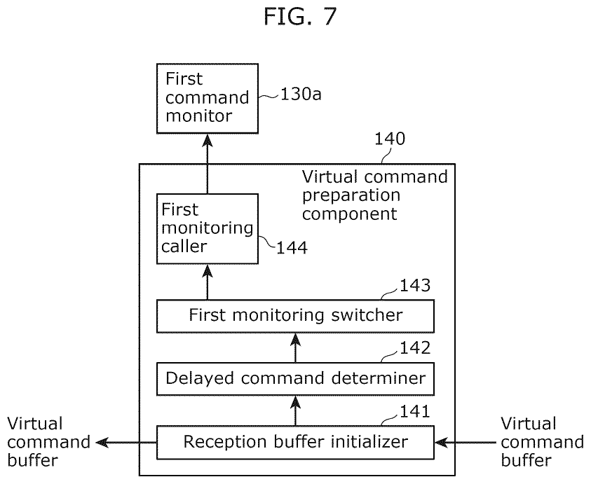

FIG. 7 is a block diagram illustrating an example of the configuration of virtual command preparation component 140.

Virtual command preparation component 140 includes reception buffer initializer 141, delayed command determiner 142, first monitoring switcher 143, and first monitoring caller 144. To ensure a storage area for storing a virtual command in the buffer, reception buffer initializer 141 initializes the storage area. Reception buffer initializer 141 then notifies virtual command generator 120 of the address of the initialized storage area. Thus, virtual command generator 120 stores the generated virtual command in the storage area of the buffer designated by the notified address.

Delayed command determiner 142 determines whether one or more virtual commands stored in the buffer include a delayed command. When determining that a delayed command is included, delayed command determiner 142 obtains the delayed command from the buffer and outputs the delayed command to first monitoring switcher 143. First monitoring switcher 143 identifies first command monitor 130a as the command monitor corresponding to the delayed command. Then, first monitoring switcher 143 causes first monitoring caller 144, associated with first command monitor 130a, to call first command monitor 130a. First monitoring caller 144 calls first command monitor 130a, and first command monitor 130a, which has been called, monitors the delayed command. The storage area of the buffer that stored the delayed command, for which monitoring was performed, is treated as the target for initialization by reception buffer initializer 141.

When virtual command transmitter C102 includes a plurality of command monitors, virtual command preparation component 140 may include a plurality of monitoring callers associated one-to-one with the plurality of command monitors. In this case, first monitoring switcher 143 selects one command monitor for a delayed command from the plurality of command monitors, thereby switching the command monitor used for monitoring the delayed command. First monitoring switcher 143 then causes the monitoring caller associated with the selected command monitor to call the command monitor. As a result, the called command monitor monitors the delayed command.

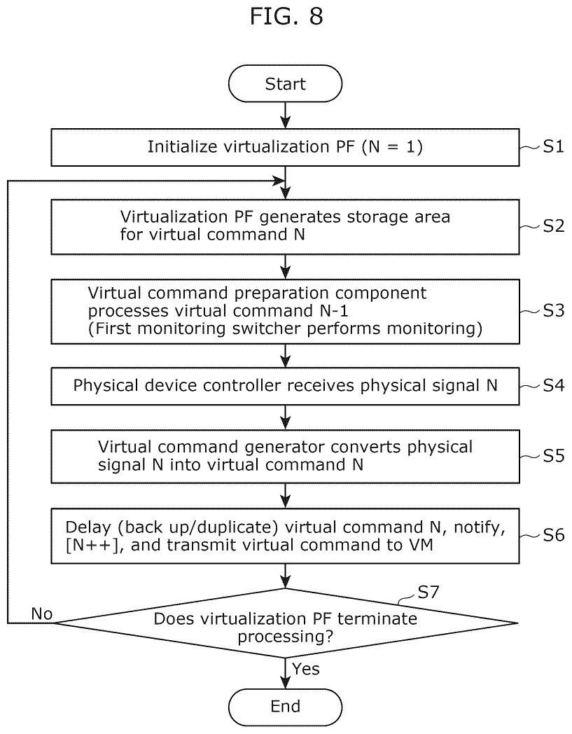

FIG. 8 is a flowchart illustrating an example of processing operations by virtualization platform 100 of integrated ECU 200. In the present disclosure, as illustrated in FIG. 8, virtualization platform 100 may be described as a virtualization PF.

First, virtualization platform 100 initializes N, which is a variable indicating the order of virtual commands to be generated (step S1). For example, virtualization platform 100 initializes variable N to N=1. Then, virtualization platform 100 generates a storage area for virtual command N in the buffer (step S2). Note that virtual command N is the Nth virtual command indicated by variable N described above.

Next, virtual command preparation component 140 executes a process for virtual command (N−1) (step S3). In other words, virtual command preparation component 140 executes a process for causing first command monitor 130a to monitor virtual command (N−1). Note that virtual command (N−1) is the (N−1)th virtual command. When N−1=0, step S3 is skipped. In step S3, specifically, virtual command preparation component 140 determines whether a delayed command, which is backed-up and duplicated virtual command (N−1), exists in the buffer. This determination may be made based on the presence or absence of marking on virtual command (N−1). The presence or absence of marking may depend on whether header h1 in FIG. 4 or the parameters in FIG. 5 indicate that the virtual command is a delayed command.

Next, physical device controller C400 receives physical signal N from network interface N1 (step S4). Note that physical signal N is a signal for generating virtual command N, a source signal of virtual command N, or a signal before conversion of virtual command N. Then, virtual command generator 120 receives physical signal N from physical device controller C400 and converts that physical signal N into virtual command N (step S5).

Next, virtual command notifier 110 determines whether to delay monitoring of virtual command N, and when determining to delay, virtual command notifier 110 backs up and duplicates virtual command N. Moreover, virtual command notifier 110 notifies virtual command preparation component 140 of the storage of duplicated virtual command N in the buffer as a delayed command. At this time, virtual command notifier 110 increments variable N described above and transmits the virtual command to the virtual machine, for example, control virtual machine VM100 (step S6).

Then, virtualization platform 100 determines whether to terminate the processing (step S7), and when determining not to terminate the processing (No in step S7), virtualization platform 100 repeatedly executes the processes from step S2. On the other hand, when determining to terminate the processing (Yes in step S7), virtualization platform 100 terminates the processing.

As described above, the monitoring apparatus, which is integrated ECU 200 according to the present embodiment, is a monitoring apparatus that monitors a virtual command, which is a command for the virtual machine, and includes virtual command generator 120, virtual command notifier 110, and virtual command preparation component 140. Virtual command generator 120 obtains a physical signal and converts the physical signal into a virtual command. Virtual command notifier 110 transmits the virtual command to the virtual machine. Virtual command preparation component 140 causes the command monitor to monitor the virtual command after the virtual command has been transmitted to the virtual machine by virtual command notifier 110.

Thus, the monitoring of the virtual command is delayed, and the virtual command is transmitted prior to the monitoring, which can reduce communication delays caused by sequential monitoring of virtual commands. When the virtual command is transmitted prior to the monitoring and is then determined to be anomalous, the occurrence or expansion of the anomaly can be appropriately prevented by prohibiting the transmission of a subsequent virtual command having similar characteristics to the anomalous virtual command. That is, even though it is difficult to completely prevent the transmission of the virtual command determined to be anomalous to the virtual machine, it is possible to perform sequential monitoring of virtual commands while eliminating communication delays. In other words, it is possible to perform proper monitoring of virtual commands while preventing degradation of communication performance.

In the present embodiment, when causing the command monitor to monitor the virtual command, virtual command preparation component 140 accesses a buffer storing at least a portion of each of the one or more virtual commands. Then, virtual command preparation component 140 determines whether at least the portion of each of the one or more virtual commands is assigned an identifier indicating that the virtual command is to be monitored after the virtual command is transmitted to the virtual machine. The identifier is, for example, a parameter indicating that the virtual command is a delayed command. Virtual command preparation component 140 then causes the command monitor to monitor the virtual command to which the identifier is assigned. Thus, the virtual command to be monitored can be identified correctly, preventing an unnecessary process such as monitoring a virtual command not to be monitored.

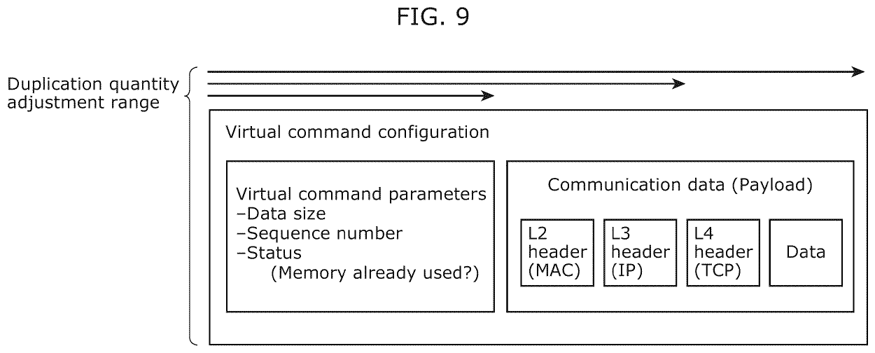

FIG. 9 is a diagram illustrating an example of virtual command duplication by virtual command notifier 110.

As illustrated in FIG. 9, virtual command notifier 110 may duplicate the entire virtual command or only a portion of the virtual command. For example, virtual command notifier 110 may duplicate only a portion of the virtual command other than communication data, that is, a plurality of parameters.

Alternatively, virtual command notifier 110 may duplicate only an area including the plurality of parameters and the L2 and L3 headers of the communication data. Note that the plurality of parameters may also include a parameter indicating the direction of packet communication.

For example, virtual command notifier 110 may switch the range of the duplication in accordance with the buffer usage rate (or load). Specifically, virtual command notifier 110 duplicates the entire virtual command when the buffer usage rate is lower than a threshold. On the other hand, virtual command notifier 110 may duplicate only a portion of the virtual command when the buffer usage rate is equal to or higher than the threshold. Alternatively, when first command monitor 130a is executing a behavior detection type algorithm that does not require inspection of all virtual commands, the processing load can be reduced by reducing the frequency of selecting a virtual command to be inspected or monitored.

As described above, in the present embodiment, virtual command notifier 110 duplicates a portion of the virtual command, assigns the identifier described above to the duplicated portion of the virtual command, and stores, into the buffer, the portion of the virtual command to which the identifier is assigned. This can reduce the generation of overhead involved in duplication. Note that the identifier assigned at this time is a parameter indicating that the virtual command is a delayed command, as described above. When a parameter indicating that the virtual command is a normal command has been preassigned to the virtual command, virtual command notifier 110 rewrites the parameter with the identifier described above when duplicating a portion of the virtual command. In other words, virtual command notifier 110 marks the duplicated portion of the virtual command.

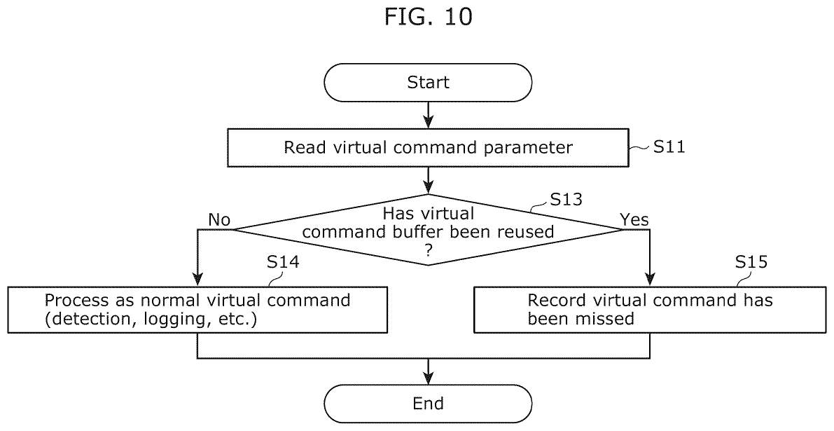

FIG. 10 is a flowchart illustrating an example of a delay processing task performed by virtual command preparation component 140.

First, virtual command preparation component 140 reads the parameter of the virtual command in the buffer (step S11). Based on the read parameter, virtual command preparation component 140 determines whether the storage area for the virtual command in the buffer has been reused (step S13). For example, virtual command preparation component 140 determines that the storage area for the virtual command has been reused when the flag or sequence number, which is the read parameter, does not match the flag or sequence number of another virtual command. In other words, it is determined that there is a broken virtual command due to the reuse of the storage area. The reuse of the storage area may be determined by inspecting the numerical value, such as the checksum, of the virtual command or by comparing the backed-up command with the command before backup.

Here, when determining that the virtual command has been reused (Yes in step S13), virtual command preparation component 140 records that a virtual command has been missed (step S15). On the other hand, when determining that the virtual command has not been reused (No in step S13), virtual command preparation component 140 processes the virtual command having the read parameter as a normal virtual command (step S14). In other words, virtual command preparation component 140 causes the command monitor to monitor the virtual command and records the log of the monitoring.

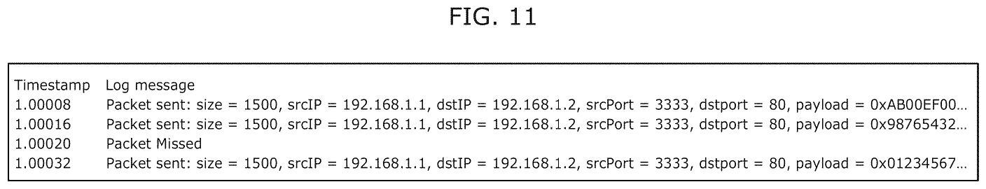

FIG. 11 is a diagram illustrating an example of the log recorded by virtual command preparation component 140.

For example, in step S15 of FIG. 10, virtual command preparation component 140 records as “Packet Missed” that a virtual command has been missed at Timestamp “1.00020”, as illustrated in FIG. 11.

As described above, in the present embodiment, virtual command preparation component 140 determines whether the storage area of the buffer has been reused, and when determining that the storage area has been reused, virtual command preparation component 140 records that a virtual command has been missed. This enables proper management of virtual commands.

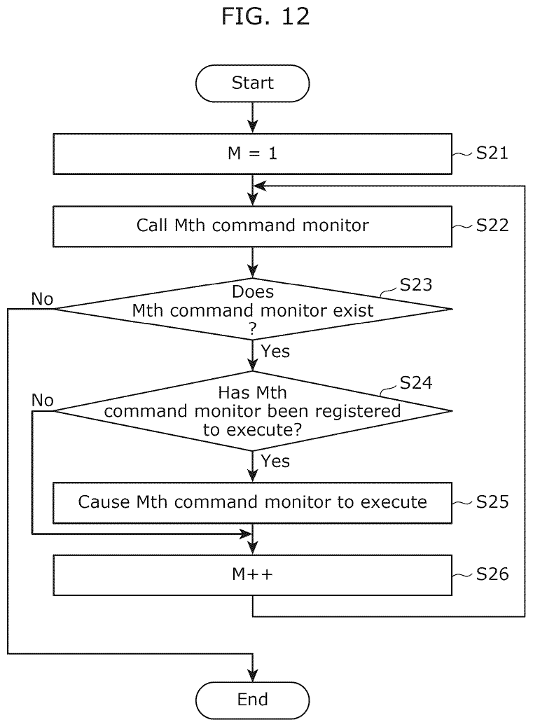

FIG. 12 is a flowchart illustrating an example of monitoring switch processing performed by virtual command preparation component 140.

First, first monitoring switcher 143 sets variable M to 1 (step S21). Next, first monitoring switcher 143 causes the Mth monitoring caller to call the Mth command monitor (step S22). The Mth monitoring caller is a monitoring caller defined by variable M. When M=1, the Mth monitoring caller is first monitoring caller 144. Similarly, the Mth command monitor is a command monitor defined by variable M. When M=1, the Mth command monitor is first command monitor 130a. Next, as a result of the call in step S22, first monitoring switcher 143 determines whether the Mth command monitor exists (step S23). Here, when determining that the Mth command monitor does not exist (No in step S23), first monitoring switcher 143 terminates the monitoring switch processing. On the other hand, when determining that the Mth command monitor exists (Yes in step S23), first monitoring switcher 143 further determines whether the Mth command monitor has been registered as an executable command monitor (step S24).

Here, when determining that the Mth command monitor has been registered as an executable command monitor (Yes in step S24), first monitoring switcher 143 causes the Mth command monitor to monitor the virtual command via the Mth monitoring caller (step S25). Then, first monitoring switcher 143 increments variable M (step S26). On the other hand, when determining in step S24 that the Mth command monitor has not been registered as an executable command monitor (No in step S24), first monitoring switcher 143 skips the process of step S25 and executes the process of step S26. After completing the process of step S26, first monitoring switcher 143 repeatedly executes the processes from step S22.

### (Variation)

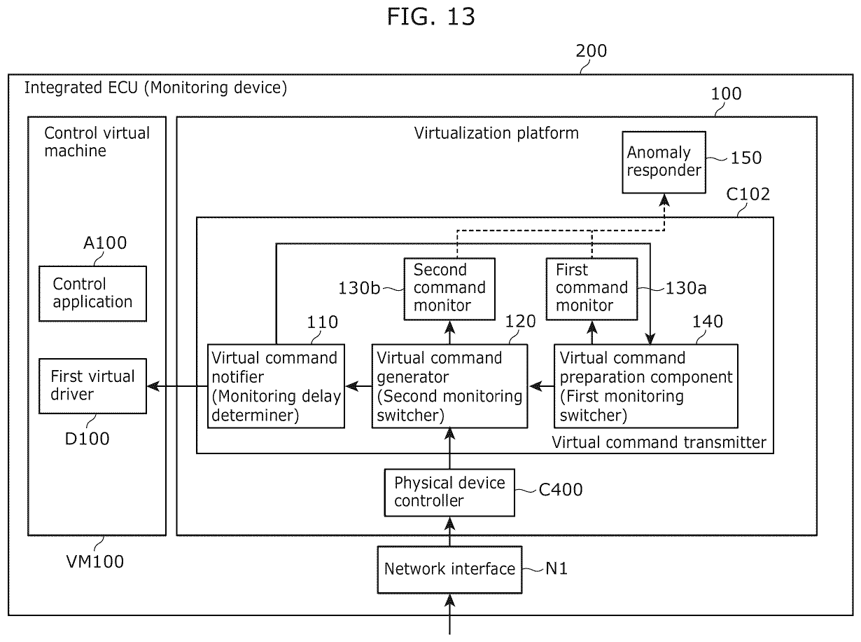

FIG. 13 is a block diagram illustrating an example of a detailed configuration of virtualization platform 100 according to the present variation.

Virtual command generator 120 of virtualization platform 100 according to the present variation, like virtual command preparation component 140, calls a command monitor to cause that command monitor to monitor the virtual command. In the present variation, virtualization platform 100 further includes second command monitor 130b as the command monitor to be called by virtual command generator 120. Here, if there is another command monitor to be called by virtual command generator 120 in addition to second command monitor 130b, virtual command generator 120 may switch the command monitor used for monitoring. In this case, virtual command generator 120 can be said to include a second monitoring switcher.

For example, each of the plurality of command monitors including first command monitor 130a and second command monitor 130b may perform a different type of monitoring. In a specific example, second command monitor 130b monitors all virtual commands. More specifically, second command monitor 130b performs monitoring based on pattern matching used in an intrusion detection system (IDS) or intrusion prevention system (IPS). Meanwhile, first command monitor 130a monitors some of the virtual commands. For example, first command monitor 130a may record statistics related to virtual command communication and perform a monitoring process on the statistical results. First command monitor 130a and second command monitor 130b may separately perform monitoring that requires blocking of virtual commands for IPS and monitoring that does not require blocking of virtual commands for IDS. Moreover, first command monitor 130a may routinely measure virtual commands to generate a monitoring rule, and second command monitor 130b may execute a process (IDS/IPS) to detect an anomalous command. Thus, virtual command generator 120 can be prevented from being delayed due to a monitoring rule generation process that is not critical to a delay.

As described above, in the present variation, different monitoring functions, such as first command monitor 130a and second command monitor 130b, coexist. For example, data areas within the virtual command monitored by first command monitor 130a and second command monitor 130b, respectively, may differ. In a specific example, first command monitor 130a may monitor the Ethernet frame (trademark registration) of the virtual command, and second command monitor 130b may monitor the VirtIO header of the virtual command. First command monitor 130a and second command monitor 130b may monitor different data portions of the virtual command.

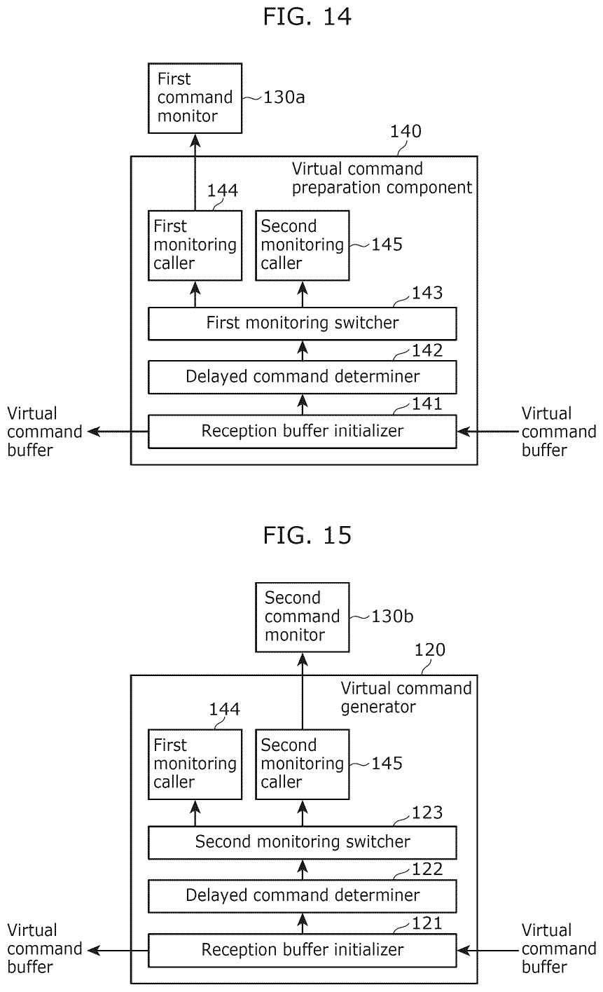

FIG. 14 is a block diagram illustrating an example of the configuration of virtual command preparation component 140 according to the present variation. FIG. 15 is a block diagram illustrating an example of the configuration of virtual command generator 120 according to the present variation.

As illustrated in FIG. 14, virtual command preparation component 140 further includes second monitoring caller 145. Note that the example of FIG. 14 illustrates a configuration in which first command monitor 130a is called.

As illustrated in FIG. 15, virtual command generator 120 includes reception buffer initializer 121, delayed command determiner 122, second monitoring switcher 123, first monitoring caller 144, and second monitoring caller 145. Second monitoring caller 145 calls second command monitor 130b, and second command monitor 130b, which has been called, monitors a delayed command. Note that the example of FIG. 15 illustrates the configuration in which second command monitor 130b is called.

Reception buffer initializer 121, delayed command determiner 122, and second monitoring switcher 123 included in virtual command generator 120 perform similar processes to reception buffer initializer 141, delayed command determiner 142, and first monitoring switcher 143 included in virtual command preparation component 140, respectively. In other words, upon generating a virtual command, virtual command generator 120 duplicates the virtual command for the purpose of monitoring, thereby generating a delayed command. The delayed command is stored into the buffer. Delayed command determiner 122 determines whether one or more virtual commands stored in the buffer include a delayed command. When determining that a delayed command is included, delayed command determiner 122 obtains the delayed command from the buffer and outputs the delayed command to second monitoring switcher 123.

Second monitoring switcher 123 identifies second command monitor 130b as the command monitor corresponding to the delayed command. Second monitoring switcher 123 then causes second monitoring caller 145 associated with second command monitor 130b to call second command monitor 130b. Second monitoring caller 145 calls second command monitor 130b, and second command monitor 130b, which has been called, monitors the delayed command. When the monitoring by second command monitor 130b determines that the delayed command is not anomalous, virtual command generator 120 transmits the virtual command to virtual command notifier 110. In other words, in the present variation, when a virtual command is generated, second command monitor 130b monitors the virtual command before the processing according to the above embodiment is executed.

Reception buffer initializer 121 initializes the storage area of the buffer that stored the delayed command for which monitoring was performed. The storage area thus initialized is used to store a subsequent virtual command or delayed command.

Note that virtual command generator 120 may cause second command monitor 130b to monitor a physical signal before conversion into a virtual command, rather than monitoring of a virtual command. In this case, upon receiving a physical signal transmitted from physical device controller C400, virtual command generator 120 stores the physical signal into the buffer. When monitoring is performed on the physical signal, virtual command generator 120 generates a delayed signal by duplicating the physical signal and stores the delayed signal into the buffer. Delayed command determiner 122 determines whether the physical signal stored in the buffer is a delayed signal. Virtual command generator 120 then causes second command monitor 130b to monitor the delayed signal instead of the delayed command.

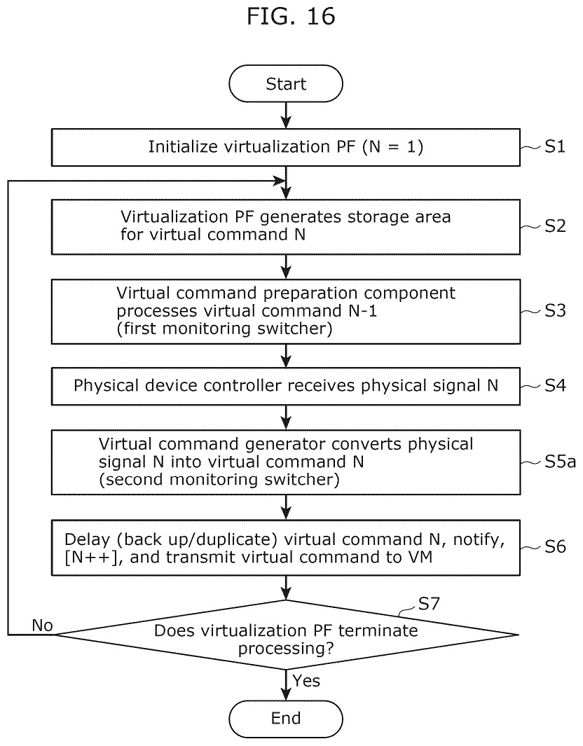

FIG. 16 is a flowchart illustrating an example of processing operations performed by virtualization platform 100 of integrated ECU 200 according to the present variation.

In the present variation, virtualization platform 100 executes the processes of steps S1 to S4, S6, and S7 illustrated in FIG. 8 of the above embodiment. Then, virtualization platform 100 according to the present variation executes the process of step S5a instead of the process of step S5 illustrated in FIG. 8.

Specifically, when physical signal N is received by physical device controller C400 in step S4 (step S4), virtual command generator 120 converts physical signal N into virtual command N (step S5a). At this time, virtual command generator 120 uses second monitoring switcher 123 to perform a process for causing second command monitor 130b to monitor the virtual command. The virtual command to be monitored can be said to be a delayed command. When the monitoring determines that the virtual command is not anomalous, virtualization platform 100 executes the processes of steps S6 and S7 in the same manner as the above embodiment. As described above, in step S5a, the physical signal may be monitored instead of the virtual command.

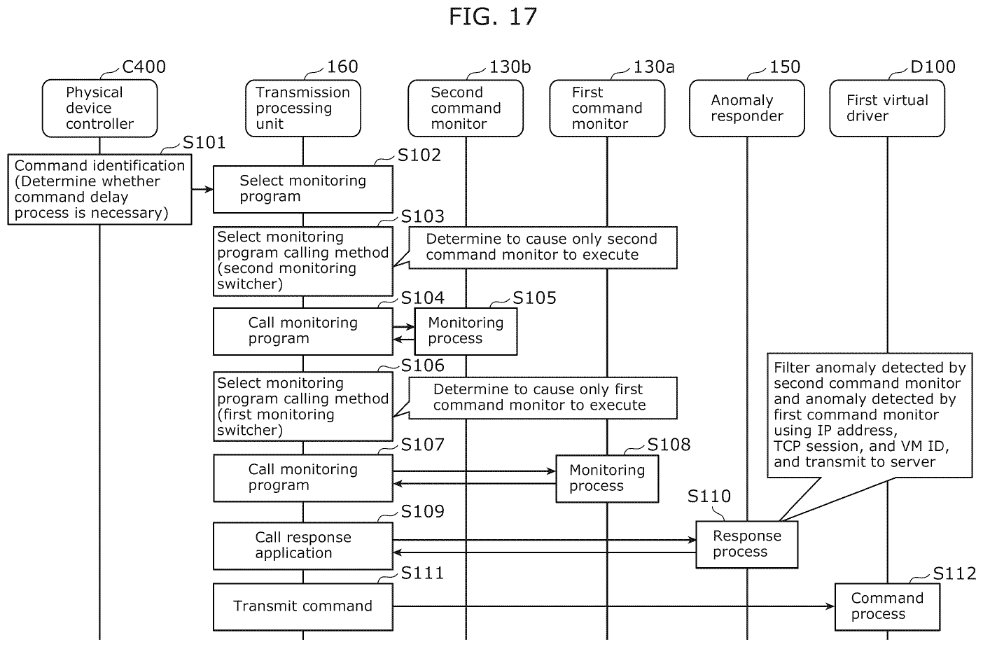

FIG. 17 is a sequence diagram illustrating processing operations performed by a plurality of components included in integrated ECU 200 according to the present variation. Note that the plurality of components of integrated ECU 200 are physical device controller C400, transmission processing unit 160, first command monitor 130a, second command monitor 130b, anomaly responder 150, and first virtual driver D100. Transmission processing unit 160 is a component including virtual command notifier 110, virtual command generator 120, and virtual command preparation component 140 within virtual command transmitter C102.

First, in the present variation, physical device controller C400 identifies a virtual command (step S101). Specifically, upon receiving a physical signal, physical device controller C400 determines whether monitoring of a virtual command generated from the physical signal needs to be delayed. In the above embodiment, virtual command notifier 110 makes such a determination of whether to delay monitoring, but as in the present variation, physical device controller C400 or other components may make this determination. In the example illustrated in FIG. 17, in step S101, it is determined that the monitoring process need not be delayed.

Next, transmission processing unit 160 selects a monitoring program (step S102). The monitoring program is, for example, the monitoring module described above. In step S102, transmission processing unit 160 selects, for example, two monitoring programs. Next, transmission processing unit 160 selects a calling method for one of the selected monitoring programs (step S103). That is, transmission processing unit 160 selects a calling method for second command monitor 130b that performs monitoring using the selected monitoring program. Thereby, second monitoring caller 145 is selected. Then, transmission processing unit 160 calls the monitoring program using that calling method (step S104). In other words, transmission processing unit 160 calls second command monitor 130b using second monitoring caller 145. Second command monitor 130b, which has been called, monitors the virtual command using the selected monitoring program described above (step S105).

Next, transmission processing unit 160 selects a calling method for the remaining one of the two monitoring programs selected in step S102 (step S106). That is, transmission processing unit 160 selects a calling method for first command monitor 130a that performs monitoring using the remaining one monitoring program. Thereby, first monitoring caller 144 is selected. Then, transmission processing unit 160 calls the monitoring program using that calling method (step S107). In other words, transmission processing unit 160 calls first command monitor 130a using first monitoring caller 144. First command monitor 130a, which has been called, monitors the virtual command using the remaining one monitoring program described above (step S108).

When the monitoring in steps S105 and S108 determines that the virtual command is anomalous, transmission processing unit 160 calls an anomaly response application that is an application software program (step S109). By this call, anomaly responder 150 that uses the anomaly response application is called. As a result, anomaly responder 150 performs an anomaly response process (step S110). For example, anomaly responder 150 performs the anomaly response process based on the respective anomaly determination results of first command monitor 130a and second command monitor 130b. Specifically, transmission processing unit 160 performs filtering using the IP address, TCP session, virtual machine (VM) ID, and other parameters of the virtual command determined to be anomalous, for example, on a plurality of virtual commands stored in the buffer. Then, transmission processing unit 160 transmits the virtual command obtained by the filtering to server 5. Note that such filtering may be performed on data that is different from the virtual command.

Next, when the anomaly response process described above is completed or when it is determined by the monitoring processes in steps S105 and S108 that the virtual command is normal, transmission processing unit 160 transmits the virtual command to the virtual machine (step S111). In a specific example, transmission processing unit 160 transmits the virtual command to first virtual driver D100 of control virtual machine VM100. Upon receiving the virtual command, first virtual driver D100 executes a process corresponding to the virtual command (step S112).

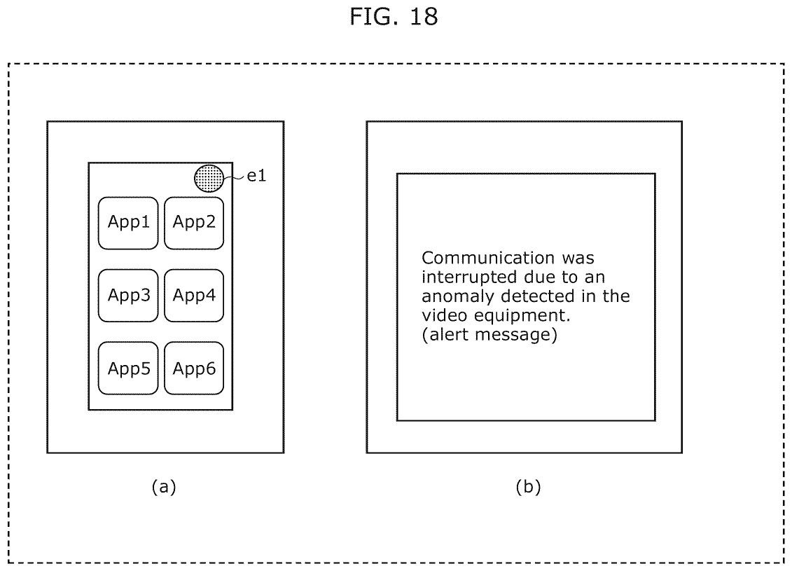

FIG. 18 is a diagram illustrating an example of an image shown on a display by screen outputter 11 of video virtual machine VM200. Note that the display may be a display provided in a vehicle in which in-vehicle system 20 is installed, or a display of a mobile terminal or the like.

For example, as illustrated in (a) of FIG. 18, screen outputter 11 displays indicator e1 on the display, indicating the anomaly determination result. When the anomaly determination result indicates an anomaly, screen outputter 11 displays red indicator e1, and when the anomaly determination result indicates normality, screen outputter 11 displays green indicator e1. Further, as illustrated in (b) of FIG. 18, screen outputter 11 may display a character string on the display, indicating the anomaly determination result and the content of the anomaly response process. For example, the character string is an alert message such as the following: Communication was interrupted due to an anomaly detected in the video equipment. Note that the image illustrated in FIG. 18 may be shown on the display not only in the present variation but also in the above embodiment.

Although the monitoring apparatus of the present disclosure has been described based on the above embodiment and its variation, the present disclosure is not limited to the above embodiment and its variation. Unless departing from the spirit of the present disclosure, various modifications conceived by a person skilled in the art and applied to the above embodiment and its variation may be included in the present disclosure.

In the above embodiment, each component may be configured by dedicated hardware or may be implemented by executing a software program suitable for each component. Each component may be implemented by a program executor, such as a central processing unit (CPU) or a processor, reading and executing a software program recorded on a recording medium, such as a hard disk or a semiconductor memory. Here, the software for implementing the monitoring apparatus or the like of the above embodiment is a computer program that causes a computer to execute each step of the flowcharts or sequence diagram illustrated in FIGS. 8, 10, 12, 16, and 17.

Note that the following cases are also included in the present disclosure.

(1) Specifically, at least one apparatus as described above is a computer system including a microprocessor, a read-only memory (ROM), a random-access memory (RAM), a hard disk unit, a display unit, a keyboard, a mouse, and the like. A computer program is stored in the RAM or the hard disk unit. At least one apparatus as described above achieves its function by the microprocessor operating according to the computer program. Here, the computer program is configured by combining a plurality of instruction codes that indicate commands to the computer to achieve a predetermined function.

(2) Some or all of the components constituting at least one apparatus as described above may be formed of a single system large-scale integrated circuit (LSI). The system LSI is a super-multifunctional LSI manufactured by integrating a plurality of components on a single chip and is specifically a computer system including a microprocessor, ROM, RAM, and the like. The RAM stores a computer program. The system LSI achieves its function by the microprocessor operating according to the computer program.

(3) Some or all of the components constituting at least one apparatus as described above may be formed of an IC card or a single module that is detachable from the device. The IC card or module is a computer system including a microprocessor, ROM, RAM, and the like. The IC card or module may include the super-multifunctional LSI. The IC card or module achieves its function by the microprocessor operating according to the computer program. The IC card or module may be tamper-resistant.

(4) The present disclosure may be the methods shown above. The present disclosure may be a computer program that implements each of these methods using a computer, or a digital signal including a computer program.

The present disclosure may also be a computer program or a digital signal recorded on a computer-readable recording medium, such as a flexible disk, a hard disk, a CD-ROM, a digital versatile disc (DVD), a DVD-ROM, a DVD-RAM, a blue-ray disc (BD), a semiconductor memory, or the like. The present disclosure may also be digital signals recorded on these recording media.

The present disclosure may also transmit a computer program or digital signal via telecommunication lines, wireless or wired communication lines, networks represented by the Internet, data broadcasting, or the like.

The present disclosure may also be implemented by another independent computer system by recording the program or digital signal on a recording medium and transferring this, or by transferring the program or digital signal via a network or the like.

While various embodiments have been described herein above, it is to be appreciated that various changes in form and detail may be made without departing from the spirit and scope of the present disclosure as presently or hereafter claimed.

Further Information about Technical Background to this Application

The disclosures of the following patent applications including specification, drawings, and claims are incorporated herein by reference in their entirety: Japanese Patent Application No. 2022-094421 filed on Jun. 10, 2022, and PCT International Application No. PCT/JP2023/003814 filed on Feb. 6, 2023.

### INDUSTRIAL APPLICABILITY

The monitoring apparatus of the present disclosure can be applied to, for example, electronic equipment installed in a vehicle.

1. A monitoring apparatus that monitors a virtual command, the virtual command being a command for a virtual machine, the monitoring apparatus comprising:
a memory; and
a processor connected to the memory,
wherein the processor:
obtains a physical signal and executes a virtual command generation process for converting the physical signal into the virtual command;
executes a virtual command notification process for transmitting the virtual command to the virtual machine; and
executes a virtual command preparation process for causing a command monitor to monitor the virtual command after the virtual command has been transmitted to the virtual machine by the virtual command notification process.

2. The monitoring apparatus according to claim 1,
wherein in the virtual command preparation process, when the processor causes the command monitor to monitor the virtual command, the processor:
accesses a buffer that stores at least a portion of each of one or more virtual commands;
determines, for each of the one or more virtual commands, whether the at least a portion of the virtual command is assigned an identifier indicating that the virtual command is to be monitored after the virtual command is transmitted to the virtual machine; and
causes the command monitor to monitor the virtual command to which the identifier is assigned.

3. The monitoring apparatus according to claim 2,
wherein in the virtual command preparation process, the processor further determines whether a storage area of the buffer has been reused, and when determining that the storage area has been reused, the processor records that a virtual command has been missed.

4. The monitoring apparatus according to claim 2,
wherein in the virtual command notification process, the processor further duplicates a portion of the virtual command, assigns the identifier to the portion of the virtual command duplicated, and stores, into the buffer, the portion of the virtual command to which the identifier is assigned.

5. A monitoring method for monitoring, by a computer, a virtual command that is a command to a virtual machine, the monitoring method comprising:
obtaining a physical signal and converting the physical signal into the virtual command;
transmitting the virtual command to the virtual machine; and
causing the command monitor to monitor the virtual command after the virtual command has been transmitted to the virtual machine.
